(19) United States
(12) Patent Application Publication
(10) Pub. No.: US 2026/0255191 A1
(43) Pub. Date: Aug. 27, 2026

(54) CONTROL CHANNEL MONITORING IN WIRELESS COMMUNICATIONS SYSTEMS

(71) Applicant: QUALCOMM Incorporated, San Diego, CA (US)

(72) Inventors: Diana MAAMARI, San Diego, CA (US); Jing JIANG, San Diego, CA (US); Gabi SARKIS, San Diego, CA (US)

(21) Appl. No.: 19/062,848

(22) Filed: Feb. 25, 2025

(51) Int. Cl. H04W 24/08; H04L 5/00; H04W 72/0453; H04W 72/232

(52) U.S. Cl. CPC H04W 24/08; H04L 5/0051; H04W 72/0453; H04W 72/232

(57) ABSTRACT

Methods, systems, and devices for wireless communications are described. A user equipment (UE) may receive control signaling that indicates a first sub-bandwidth part (subBWP) of a bandwidth part (BWP) and a second subBWP of a BWP, where a first set of frequency resources associated with the first subBWP is greater than a second set of frequency resources associated with the second subBWP. The UE may receive, via the second subBWP, an indication to monitor the first subBWP for reception of a control channel, and the UE may monitor the first subBWP for the reception of the control channel in accordance with the indication.

### FIELD OF TECHNOLOGY

The following relates to wireless communications, including control channel monitoring in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that indicates a first sub-bandwidth part (subBWP) of a bandwidth part (BWP) and a second subBWP of the BWP, where a first set of frequency resources associated with the first subBWP is greater than a second set of frequency resources associated with the second subBWP, receiving, via the second subBWP, an indication to monitor the first subBWP for reception of a control channel, and monitoring the first subBWP for the reception of the control channel in accordance with the indication.

A UE for wireless communications is described. The UE may include one or more memories storing processor executable code, and one or more processors coupled with the one or more memories. The one or more processors may individually or collectively be operable to execute the code to cause the UE to receive control signaling that indicates a first subBWP of a BWP and a second subBWP of the BWP, where a first set of frequency resources associated with the first subBWP is greater than a second set of frequency resources associated with the second subBWP, receive, via the second subBWP, an indication to monitor the first subBWP for reception of a control channel, and monitor the first subBWP for the reception of the control channel in accordance with the indication.

Another UE for wireless communications is described. The UE may include means for receiving control signaling that indicates a first subBWP of a BWP and a second subBWP of the BWP, where a first set of frequency resources associated with the first subBWP is greater than a second set of frequency resources associated with the second subBWP, means for receiving, via the second subBWP, an indication to monitor the first subBWP for reception of a control channel, and means for monitoring the first subBWP for the reception of the control channel in accordance with the indication.

A non-transitory computer-readable medium storing code for wireless communications is described. The code may include instructions executable by one or more processors to receive control signaling that indicates a first subBWP of a BWP and a second subBWP of the BWP, where a first set of frequency resources associated with the first subBWP is greater than a second set of frequency resources associated with the second subBWP, receive, via the second subBWP, an indication to monitor the first subBWP for reception of a control channel, and monitor the first subBWP for the reception of the control channel in accordance with the indication.

Some examples of the method, UEs, and non-transitory computer-readable medium described herein may further include operations, features, means, or instructions for receiving, in accordance with monitoring the first subBWP and via the control channel, downlink control information (DCI) that schedules communication of a data channel via one of the first subBWP or the second subBWP and receiving the data channel via one of the first subBWP or the second subBWP in accordance with the DCI.

Some examples of the method, UEs, and non-transitory computer-readable medium described herein may further include operations, features, means, or instructions for receiving, via the DCI, an indication of a time offset between reception of the DCI and reception of the data channel, where the time offset may be greater than zero, and where the data channel may be received in accordance with the time offset.

In some examples of the method, UEs, and non-transitory computer-readable medium described herein, the time offset indicates that reception of the data channel corresponds to a first slot that may be subsequent to a second slot associated with reception of the DCI.

In some examples of the method, UEs, and non-transitory computer-readable medium described herein, the DCI may be received in a first slot and schedules the communication of the data channel in the first slot and the data channel may be received via the first slot.

In some examples of the method, UEs, and non-transitory computer-readable medium described herein, the DCI schedules the data channel in the second subBWP, the UE decodes the data channel received via the second subBWP according to a first duration, and the UE communicates feedback associated with the data channel received via the second subBWP according to a second duration and the DCI schedules the data channel in the first subBWP, the UE decodes the data channel received vis the first subBWP according to a third duration, and the UE communicates feedback associated with the data channel received via the first subBWP according to a fourth duration.

In some examples of the method, UEs, and non-transitory computer-readable medium described herein, the first duration may be greater than the third duration and the second duration may be greater than the fourth duration.

Some examples of the method, UEs, and non-transitory computer-readable medium described herein may further include operations, features, means, or instructions for obtaining, while monitoring the first subBWP, one or more serving cell measurements and switching to monitor the second subBWP in accordance with the one or more serving cell measurements satisfying one or more thresholds.

Some examples of the method, UEs, and non-transitory computer-readable medium described herein may further include operations, features, means, or instructions for receiving, while monitoring the first subBWP, a second indication to monitor the second subBWP and monitoring the second subBWP in accordance with the indication.

Some examples of the method, UEs, and non-transitory computer-readable medium described herein may further include operations, features, means, or instructions for monitoring the second subBWP for reception of a second control channel and switching from monitoring the second subBWP to monitoring the first subBWP in accordance with a combination of a channel quality indicator (CQI) of the second control channel and a quantity of activated antennas at the UE for receiving the second control channel satisfying a threshold.

Some examples of the method, UEs, and non-transitory computer-readable medium described herein may further include operations, features, means, or instructions for transmitting an indication indicating that the UE may be to monitor the first set of frequency resources in response to the switching.

Some examples of the method, UEs, and non-transitory computer-readable medium described herein may further include operations, features, means, or instructions for monitoring the second subBWP for reception of a second control channel and switching from monitoring the second subBWP to monitoring the first subBWP in accordance with one or more synchronization signal block (SSB) measurements satisfying a threshold.

Some examples of the method, UEs, and non-transitory computer-readable medium described herein may further include operations, features, means, or instructions for monitoring a control resource set (CORESET) associated with the second subBWP for a second control channel, where the CORESET includes three or more symbols.

In some examples of the method, UEs, and non-transitory computer-readable medium described herein, the indication includes a DCI message associated with a first DCI format, the first DCI format may be associated with a first payload size that may be smaller than a second payload size associated with a second DCI format that may be utilized for scheduling one or more data channels, and the first DCI format may be associated with a first cyclic redundancy check (CRC) size that may be smaller than a second CRC size associated with the second DCI format.

In some examples of the method, UEs, and non-transitory computer-readable medium described herein, the indication includes a single bit of a demodulation reference signal (DMRS).

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports control channel monitoring in wireless communications systems in accordance with one or more aspects of the present disclosure.

FIG. 2 shows an example of a wireless communications system that supports control channel monitoring in wireless communications systems in accordance with one or more aspects of the present disclosure.

FIG. 3 shows an example of a timing diagram that supports control channel monitoring in wireless communications systems in accordance with one or more aspects of the present disclosure.

FIG. 4 shows an example of a state diagram that supports control channel monitoring in wireless communications systems in accordance with one or more aspects of the present disclosure.

FIG. 5 shows an example of a process flow that supports control channel monitoring in wireless communications systems in accordance with one or more aspects of the present disclosure.

FIGS. 6 and 7 show block diagrams of devices that support control channel monitoring in wireless communications systems in accordance with one or more aspects of the present disclosure.

FIG. 8 shows a block diagram of a communications manager that supports control channel monitoring in wireless communications systems in accordance with one or more aspects of the present disclosure.

FIG. 9 shows a diagram of a system including a device that supports control channel monitoring in wireless communications systems in accordance with one or more aspects of the present disclosure.

FIGS. 10 through 11 show flowcharts illustrating methods that support control channel monitoring in wireless communications systems in accordance with one or more aspects of the present disclosure.

### DETAILED DESCRIPTION

In some wireless communications systems, a network entity and a user equipment (UE) may communicate via a bandwidth part (BWP), which may include a portion of a frequency bandwidth corresponding to a communication channel between the network entity and the UE. In some cases, the BWP may include one or more sub-BWPs (subBWPs), including a first subBWP (e.g., subBWP0, a low power subBWP) and a second subBWP (e.g., subBWP1, a high-power subBWP), where the second subBWP may include a greater quantity of frequency resources (e.g., may be relatively wider than) relative to the first subBWP. In some cases, to avoid one or more out-of-sync (OOS) scenarios, in which the network entity is operating according to the first subBWP and the UE is operating to the second subBWP (or vice versa), the network entity may indicate for the UE to switch between the subBWPs.

To do so, the network entity may output downlink control information (DCI) via a physical downlink control channel (PDCCH) that indicates for the UE to switch between the subBWPs. In such cases, however, the UE may be unable to receive and decode the DCI in cases that the UE operates according to the first subBWP (e.g., the low power subBWP), leading to the occurrence of the OOS scenarios. For example, while operating in the first subBWP, the UE may be unable to utilize various aggregation levels for communications with the network entity due to the relatively limited resources of the first subBWP. As such, because the UE may operate using limited aggregation levels, the UE may be unable to receive and decode the DCI, leading to OOS issues, increased latency, and communication failures within the wireless communications systems.

The techniques, methods, and devices described herein provide signaling techniques to enable the UE to receive and decode the DCI while operating in the first subBWP. For example, the network entity may output, to the UE operating according to the first subBWP (e.g., low power subBWP), an indication for the UE to switch to monitoring for PDCCHs within the second subBWP (e.g., high-power subBWP). To increase the reliability of such indications, the network entity may output a DCI that is formatted according to a first DCI format (e.g., a compact DCI), where the first DCI format may include a smaller payload size, a smaller cyclic redundancy check (CRC) size, or both relative to a second DCI format associated with scheduling data channels. Additionally, or alternatively, the network entity may output a demodulation reference signal (DMRS), which may include a bit (e.g., is encoded with one bit) that indicates for the UE to switch to the second subBWP. Accordingly, the UE may receive the DCI formatted according to the first DCI format or the DMRS within the first subBWP and may switch to the second subBWP.

The compact DCI may be used to indicate to the UE to switch to the wider subBWP for control channel monitoring. The compact DCI may have a smaller payload than DCI scheduling DCIs, such that the compact DCI transmission may benefit from increased channel code redundancy. A UE may be addressed with a specific radio network temporary identifier (RNTI) when receiving the compact DCI. The UE may be addressed with the RNTI to scramble the CRC bits, which are added to the DCI payload. The DCI may include a subBWP identifier (ID) for UE to switch monitoring the control channel. The indication to switch monitoring the control channel may indicate to monitor a second subBWP. In one embodiment, switching to the second subBWP means switching to a wider subBWP for monitoring the control channel, but data transmission and/or reception may still be within the first subBWP (e.g., decouple control and data). The DCI may include the indication of whether to switch to the second subBWP for data and/or whether the control channel is decoupled or not.

In one embodiment, instead of compact DCI, the indication may be a sequence such as an on-off keying (OOK) sequence. For example, the OOK sequence may indicate for the UE to switch from the first subBWP to the second subBWP.

By performing one or more of the techniques described herein, the network entity may output an indication to switch subBWPs, such as the DCI formatted according to the first DCI format or the bit of the DMRS, which may be more likely to be received and decoded by the UE compared to a DCI of a different format. For example, the UE may receive the indication with an increased likelihood due to the reduced payload size and reduced CRC size of the first DCI format. Due to the increased likelihood of reception by the UE, the techniques described herein may lead to a decrease in OOS scenarios between the network entity and the UE, which may decrease a quantity of missed communications, decrease latency, and increase communication reliability.

Aspects of the disclosure are initially described in the context of wireless communications systems. Aspects of the disclosure are further described in the context of wireless communications systems, communication timelines, state diagrams, and process flows. Aspects of the disclosure are further illustrated by and described with reference to apparatus diagrams, system diagrams, and flowcharts that relate to control channel monitoring in wireless communications systems.

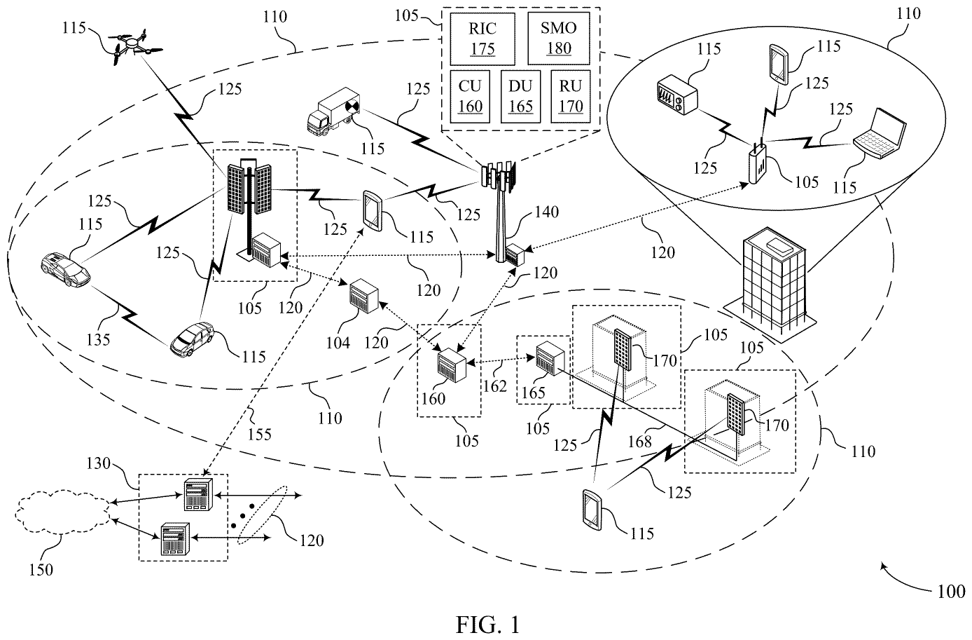

FIG. 1 shows an example of a wireless communications system 100 that supports control channel monitoring in wireless communications systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support control channel monitoring in wireless communications systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The techniques, methods, and devices described herein provide signaling techniques to enable the UE 115-a to receive and decode the DCI while operating in the first subBWP. For example, the network entity 105-a may output, to the UE 115-a operating according to the first subBWP (e.g., low power subBWP), an indication for the UE 115-a to switch to monitoring for PDCCHs within the second subBWP (e.g., high-power subBWP). To increase the reliability of such indications, the network entity 105-a may output a DCI that is formatted according to a first DCI format, where the first DCI format may include a smaller payload size, a smaller cyclic redundancy check (CRC) size, or both relative to a second DCI format associated with scheduling data channels. Additionally, or alternatively, the network entity 105-a may output a DMRS, which may include a bit (e.g., is encoded with one bit) that indicates for the UE 115-a to switch to the second subBWP. Accordingly, the UE 115-a may receive the DCI formatted according to the first DCI format or the DMRS within the first subBWP and may switch to the second subBWP.

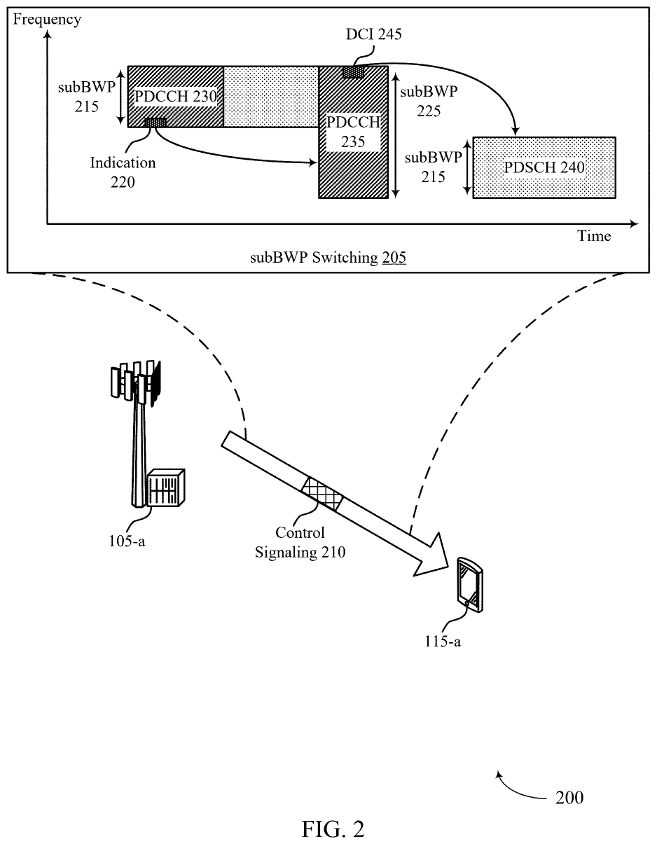

FIG. 2 shows an example of a wireless communications system 200 that supports control channel monitoring in wireless communications systems in accordance with one or more aspects of the present disclosure. Aspects of the wireless communications system 200 may implement, or be implemented by, aspects of the wireless communications system 100. For example, the wireless communications system 200 may include a network entity 105-a and a UE 115-a, which may be examples of the network entity 105 and the UE 115 respectively. The techniques described in the context of the wireless communications system 200 may enable the network entity 105-a to indicate for the UE 115-a to switch from a subBWP 215 to a subBWP 225 with increased reliability, thereby avoiding OOS issues.

In some cases, BWPs may enable relatively fast and low-signaling overhead adaptation of radio parameters. For example, RRC parameters may be organized in a BWP container, and a BWP change may be indicated (e.g., happen) via RRC or DCI signaling, or with expiration of a BWP inactivity timer (IAT). In some cases, the use of BWPs may relatively simplify switching parameters that impact UE power (e.g., a power consumption of the UE 115-a, among other examples). For example, changing BWPs may change a monitored bandwidth from 20 MHz to 100 MHz when large data (e.g., a large data payload) is to be transmitted to the UE 115-a, while the UE 115-a may otherwise monitor the 20 MHz bandwidth.

In some cases, OOS issues may occur due to missed (e.g., naturally missed) switching DCI, ghost DCI, discontinuous transmission and reception (DTX) cycles (e.g., physical uplink shared channel (PUSCH) DTX, or the like), or conflict windows, among other examples. In such cases, a network (e.g., such as the network entity 105-a) may switch to a new BWP (e.g., a BWP different from a BWP of the UE), and the UE 115-a may stay in an old BWP, or the UE 115-a may switch to a new BWP while the network entity 105-a stays in the old BWP. Such scenarios may complicate UE 115-a handling to accommodate for different network implementations. For time domain BWPs (TD-BWPs), such OOS scenarios may be relatively less severe because some time occasions are common (e.g., some scheduled time occasions for communications may overlap despite the OOS condition). For frequency domain BWPs (FD-BWPs) or rank changes, such OOS scenarios may be relatively more severe because DCIs may be undecodable.

In some cases, a switch from a first BWP to a second BWP may correspond to a switching delay (e.g., T_{BWPswitchingDelay}, among other examples). The switching delay may correspond to a quantity of slots between receiving an indication to switch BWPs and switching from the first BWP to the second BWP. For example, the UE may operate according to the first BWP and may receive an indication (e.g., a DCI, or the like) to switch from the first BWP to the second BWP. The UE may switch to operating according to the second BWP during a slot indicated by the switching delay. That is, the UE may switch to operating within the second BWP a threshold quantity of slots after receiving the indication, where the threshold quantity of slots is indicated by T_{BWPswitchingDelay}, or the like. The UE may receive an indication of T_{BWPswitchingDelay} via the received indication, among other examples. The quantity of symbols indicated by T_{BWPswitchingDelay} may vary according to one or more parameters including a subcarrier spacing (SCS) (e.g., μ), a slot length (e.g., in milliseconds (ms), or the like), a capability of the UE, or the like. A set of T_{BWPswitchingDelay} values is given in Table 1, which is shown below.

TABLE 1
BWP Switch Delay

| | |
|---|---|
| Slot | |
| Length | BWP Switch Delay T_{BWPswitchingDelay} (Slots) |

| μ | (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the smaller SCS between the SCS before BWP switch and the SCS after BWP switch.

In some cases, time, frequency, and antenna adaptation may save UE energy (e.g., decrease a power consumption of the UE 115-a), where such BWP switching may enable such adaptation. However, such BWP switching may incur relatively high penalties for OOS scenarios of an active BWP between the network entity 105-a and UE 115-a. Additionally, or alternatively, BWP switching may include a relatively long switching time based on the switching including receiving and updating a relatively large quantity of communication parameters, among other examples.

In some cases, one or more other BWP designs (e.g., BWP switching designs) may change (e.g., reconfigure) a relatively large quantity of RRC parameters including DCI parameters, control resource sets (CORESETs), or the like. As such, a timeline to switch such parameters from a first BWP to a second BWP may be relatively long and may incur OOS penalties. Additionally, or alternatively, if the UE 115-a switches to a new BWP while the network entity 105-a is in the old BWP, the DCI size and fields may change, making the DCI undecodable.

In some cases, a BWP switch may include updating (e.g., adapting), without affecting a size of a DCI or one or more fields of the DCI, a bandwidth, a quantity of active antennas, a rank, or a search space periodicity, among other examples. In such cases, the BWP switch may not include updating a CORESET (e.g., a CORESET of the UE 115-a). In such cases (e.g., light adaptation), a DCI may be consistent across multiple BWPs (e.g., remain unchanged throughout adaptation without affecting DCI size and fields), which may enable the UE 115-a to decode DCI when OOS and) and may reduce an amount of reprogramming of the UE 115-a.

A timeline for the BWP switch may include a scheduling offset (e.g., a minimum scheduling offset) between a switching DCI and a corresponding control channel reception (e.g., a PDCCH reception), or a scheduling offset between a DCI and subsequent data communications (e.g., physical downlink shared channel (PDSCH) communications, among other examples). For example, switching may be accompanied with a scheduling delay (K0 or K2) (e.g., K0/K2>0). Such cases may result in relatively reduced power consumption of the UE 115-a (e.g., compared to a fully narrow band or fully wideband configuration).

To further support such light adaptation, the network entity 105-a may output an indication of a (e.g., allocate, or define, among other examples) configuration for two or more sub-BWPs per BWP. For example, the network entity 105-a may indicate a BWP including a low power subBWP (e.g., subBWP0) such as the subBWP 215, a high-power subBWP (e.g., subBWP1), such as the subBWP 225, or both. In such cases, the network entity 105-a may output a DCI that explicitly signals a switch between the subBWP 215 and the subBWP 225. In some cases, the network entity 105-a may indicate the switch according to a switching timeline (e.g., a switching timeline may be defined). For example, the network entity 105-a may indicate, via the DCI, a switch from a first subBWP to a different subBWP in a next slot (e.g., a slot after the DCI is received), among other examples. In such cases, the network entity 105-a may adapt a set of communication parameters via the indication of the DCI, and a DCI field size relevant to adapted parameters may be independent of an active subBWP (e.g., a subBWP utilized for communications between the network entity 105-a and the UE 115-a), which may relatively reduce a quantity of parameters reconfigured with each switch between subBWPs. That is, the network entity 105-a may utilize a DCI of a same field size regardless of whether the UE 115-a is operating according to the subBWP 215 or the subBWP 225.

In some cases, the subBWP 215 (e.g., low power state subBWP, or narrow subBWP) may include relatively fewer frequency resources than the subBWP 225 (e.g., limited bandwidth). The subBWP 225 (e.g., high-power state subBWP, or wide subBWP) may include a relatively wider bandwidth (e.g., compared to the subBWP 215). As such, a UE 115-a operating according to the subBWP 215 may be unable to receive communications corresponding to frequency resources beyond the bandwidth of the subBWP 215.

In some cases, if the UE 115-a monitors for PDCCH communications in the subBWP 215, the UE 115-a may be unable to receive communications according to some aggregation levels. That is, the UE 115-a may, operating according to some aggregation levels, utilize a quantity of control channel elements (CCEs) corresponding to available frequency domain resources (e.g., within a BWP). As such, the UE 115-a may be unable to achieve the aggregation levels based on a quantity of CCEs available within the subBWP 215. For example, the UE 115-a may operate according to the subBWP 215, and the subBWP 215 may correspond to a bandwidth of 20 MHz. As such, the UE 115-a may be unable to achieve (e.g., operate according to) an aggregation level of 16. In such cases, some UEs (e.g., coverage-limited UEs such as the UE 115-a, or other UEs), may be unable to decode some DCIs based on the unavailable aggregation levels (e.g., higher aggregation levels).

In some cases, the network entity 105-a may output an indication (e.g., an explicit indication) to the UE 115-a indicating for the UE 115-a to switch to monitoring for DCI in the subBWP 225. That is, the network entity 105-a may output control signaling (e.g., a scheduling or non-scheduling DCI, or a CRC scrambled message according to a special radio network temporary identifier (RNTI)), in accordance with the subBWP 215. Additionally, or alternatively, the network entity 105-a may output one or more repetitions of the DCI (e.g., PDCCH repetition). However, the UE 115-a may be unable to transition to the wider subBWP to monitor for DCIs (e.g., scheduling DCIs) in the subBWP 225 based on the higher aggregation levels being unavailable.

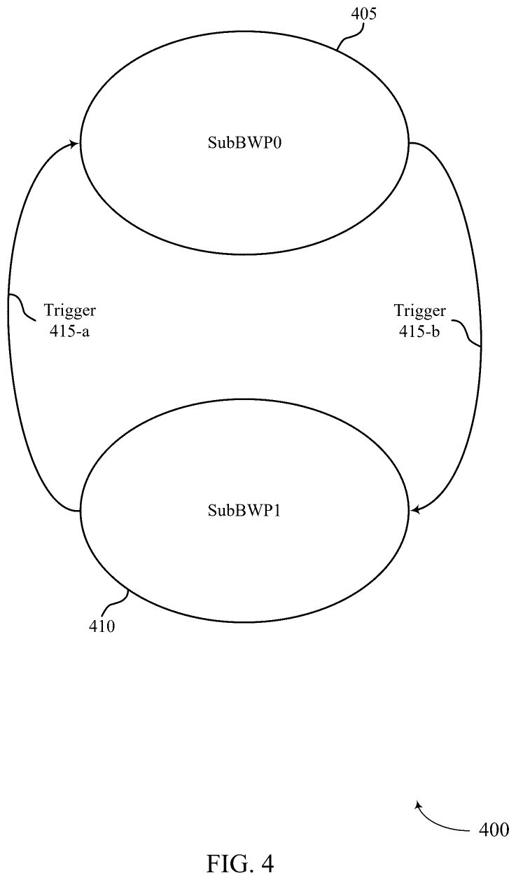

The techniques, methods, and devices described herein may support PDCCH monitoring with light adaptation in accordance with one or more aspects of the present disclosure. For example, the UE 115-a may switch from communicating (e.g., monitoring) within the subBWP 215 (subBWP0, or narrow subBWP) to monitoring for control channel communications in the subBWP 225 (subBWP1, or wide subBWP) according to a subBWP switching 205, among other examples. In some examples, the UE 115-a may switch (e.g., toggle) between the subBWP 215 and the subBWP 225 according to one or more events, as further described herein with reference to FIG. 4.

For example, the network entity 105-a may output control signaling 210 indicating, as part of a BWP configuration, at least the subBWP 215 and the subBWP 225. That is, the control signaling 210 may include an indication of a set of parameters (e.g., frequency resources) associated with the subBWP 215 and the subBWP 225, respectively. The subBWP 225 may include a greater quantity of frequency resources than the subBWP 215. That is, the subBWP 225 (e.g., the wide subBWP) may have a greater bandwidth than the subBWP 215 (e.g., the narrow subBWP). In some implementations, the UE 115-a may monitor the subBWP 215 for communications based on receiving the indication via the control signaling 210.

To facilitate subBWP switching 205, the network entity 105-a may output, via PDCCH 230, an indication 220, which may indicate for the UE 115-a to switch subBWPs. For example, the UE 115-a may be operating according to the subBWP 215 and receive, while monitoring the PDCCH 230, the indication 220. Accordingly, the UE 115-a may switch from communicating (e.g., monitoring) within the narrow subBWP (subBWP 215) to monitoring for control channel communications in the wide subBWP (subBWP 225) based on an indication 220 (e.g., an explicit indication) received in the low power state subBWP 215.

In some examples, the network entity 105-a may output, as the indication 220, a DCI (e.g., a special format DCI), which may include a relatively smaller payload size, a relatively smaller CRC (e.g., with coding gain), or both compared to other DCI messages. That is, the network entity 105-a may output the indication 220 according to a DCI format having a smaller payload size, a smaller CRC size, or both compared to one or more different DCI formats, such as DCI formats that are used to schedule one or more PDSCHs 240. Additionally, or alternatively, the network entity 105-a may output, as the indication 220, an encoded DMRS, where one or more bits (e.g., one bit) of the DMRS indicate for the UE 115-a to switch to the subBWP 225 for monitoring. That is, one bit of the DMRS may convey the indication 220.

In response to receiving the indication 220, the UE 115-a may switch to the subBWP 225 and monitor the subBWP 225 for a PDCCH 235 (e.g., a PDCCH corresponding to the subBWP 225). In some examples, the UE 115-a may receive, via the PDCCH 235 in accordance with monitoring the subBWP 225, a DCI 245 (e.g., subsequent DCIs via the subBWP 225, or the like) that schedules a PDSCH 240.

For example, the network entity 105-a may schedule, via the DCI 245, the PDSCH 240. In some examples, the network entity 105-a may schedule the PDSCH 240 as cross-subBWP communications. That is, the network entity 105-a may schedule, via the DCI 245, the communication of the PDSCH 240 within a subBWP that is different than a subBWP that the network entity 105-a and the UE 115-a may be currently operating within. For example, the UE 115-a may receive the DCI 245 within the PDCCH 235 and according to the subBWP 225, and the DCI 245 may schedule a PDSCH 240 within the subBWP 215. Additionally, or alternatively, the network entity 105-a may schedule the one or more subsequent PDSCHs 240 within a same subBWP that the network entity 105-a and the UE 115-b may be currently operating within (e.g., self-schedule in the same subBWP).

As an illustrative example, the network entity 105-a may output, and the UE 115-a may receive, the control signaling 210 including an indication of a BWP configuration for the subBWP 215 and the subBWP 225. The UE 115-a may monitor the subBWP 215 based on receiving the control signaling 210. Accordingly, the UE 115-a may receive, via the PDCCH 230, the indication 220 indicating for the UE 115-a to switch to monitoring the subBWP 225, and the UE 115-a may correspondingly switch to the subBWP 225. In such examples, the UE 115-a may receive, via the PDCCH 235, the DCI 245 scheduling a PDSCH 240 in the subBWP 215. As such, the UE 115-a may switch to monitoring the subBWP 215, and the UE 115-a may receive, based on monitoring the subBWP 215, the PDSCH 240. Alternatively, the UE 115-a may receive, via the PDCCH 235, the DCI 245 scheduling the PDSCH 240 in the subBWP 225 (not shown). Accordingly, the UE 115-a may refrain from switching subBWPs, and instead may monitor the subBWP 215 to receive the PDSCH 240.

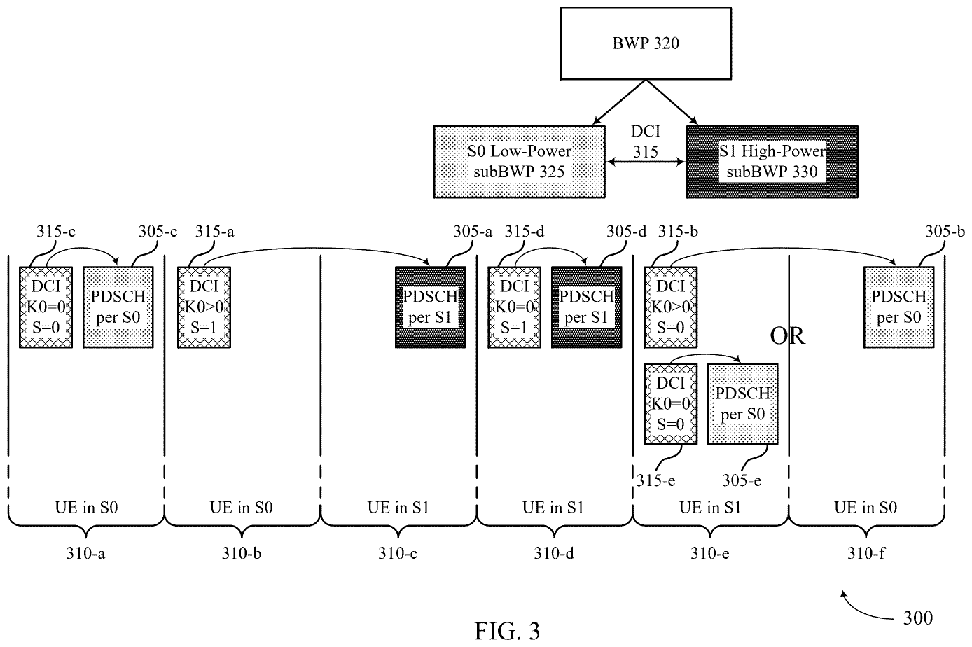

To support such scheduling, the network entity 105-a may ensure that a scheduling delay (e.g., K0, a quantity of slots, a time delay, among other examples), indicated via the DCI 245, from reception of the DCI 245 to a start of the PDSCH 240 is greater than a minimum threshold (e.g., K0>0) and may refrain from same slot scheduling in order to enable the UE 115-a to adapt radio frequency settings. In some other examples, if the UE 115-a supports same slot scheduling for both cross-subBWP scheduling or self-scheduling in the same subBWP, the network entity 105-a may schedule the PDSCH 240 to be received in a same slot as the DCI 245. In such examples, the UE 115-a may save baseband power (e.g., but may not save radio frequency power and may open the radio frequency wide to receive the narrow PDSCH or transmit PUSCH). Such techniques may be further described herein with reference to FIG. 3.

In some implementations, the UE may transition from the subBWP 215 to the subBWP 225 (e.g., based on the indication 220, for example) and may monitor the subBWP 225 until receiving a subsequent indication to switch subBWPs (e.g., indication 220 is sticky), or until one or more different conditions are satisfied (e.g., temporary), as further described herein with reference to FIG. 4. For example, the UE 115-a may continue to monitor the subBWP 225 until receiving an additional indication (e.g., a second indication 220) indicating for the UE 115-a to switch back to the subBWP 215 (e.g., stick indication). Additionally, or alternatively, the UE 115-a may perform one or more serving cell measurements while operating according to the subBWP 225, and the UE 115-a may switch to the subBWP 215 based on the measurements satisfying one or more thresholds (e.g., temporary indication).

In some implementations, the UE 115-a may monitor the subBWP 215 and may transition to the subBWP 225 based on one or more events. For example, the UE 115-a may, while monitoring the subBWP 215, perform one or more measurements, such as PDCCH channel quality indicator (CQI) measurements, serving cell radio link monitoring (RLM) measurements, or the like. Accordingly, the UE 115-a may transition to the subBWP 225 from the subBWP 215 based on the PDCCH CQI measurements, the serving cell RLM measurements, a quantity of active antennas, or any combination thereof satisfying one or more thresholds. Such techniques may be further described herein with reference to FIG. 4.

In some implementations, the UE 115-a may utilize one or more CORESETs that are extended in time (e.g., long CORESETs) to monitor for the PDCCH 230 while operating in the subBWP 215. For example, the UE 115-a may, while operating according to the subBWP 215, utilize a CORSET (e.g., a long CORESET, or a CORESET including three or more symbols) to achieve higher aggregation levels for reception of the PDCCH 230. Such techniques may be further described herein with reference to FIG. 3.

In some other implementations, the UE 115-a may utilize control channel elements (CCEs) that are the union of one or more search space sets (SSSs) in a same or different CORESET for reception of the PDCCH 230 while operating in the subBWP 215. That is, if the UE 115-a is monitoring the PDCCH 230 in subBWP 215, the UE 115-a may achieve greater aggregation levels by using CCEs that are the union across one or more SSSs in same or different CORESETs. Such techniques may be further described herein with reference to FIG. 3.

In some implementations, if the UE 115-a is monitoring a PDCCH 235 in the subBWP 225 and being scheduled, via the DCI 245, with the PDSCH 240 in the subBWP 215, the UE 115-b may utilize a relaxed timeline to decode the PDCCH 235, for example, by utilizing a relaxation of an N1 timeline (e.g., timeline to decode the PDSCH 240) and/or K1 timeline (e.g., timeline to provide feedback of the PDSCH 240).

For example, the UE 115-a may receive, while operating according to the subBWP 225 (e.g., monitoring resources according to the subBWP 225), the DCI 245 scheduling the PDSCH 240 in the subBWP 215. As such, the UE 115-a may decode PDSCH 240 according to a relaxed timeline relative to decoding a PDSCH 240 received via the subBWP 225 and may provide feedback associated with the PDSCH 240 according to a relaxed timeline relative to providing feedback for a PDSCH 240 received via the subBWP 225. By doing so, the UE 115-a may have an extended period of time to monitor for and decode the PDCCH 235 to obtain the DCI 245.

FIG. 3 shows an example of a timing diagram 300 that supports control channel monitoring in wireless communications systems in accordance with one or more aspects of the present disclosure. Aspects of the timing diagram 300 may implement, or be implemented by, aspects of the wireless communications system 100, the wireless communications system 200, or both. For example, the timing diagram 300 may be implemented between a network entity and a UE, which may be examples of the network entity 105 and the UE 115, respectively.

In some implementations, the network entity may schedule one or more PDSCHs 305 according to the timing diagram 300. In such examples, after the network entity has transmitted the DCI 315 to indicate the switch between the two subBWPs of the BWP 320, the network entity may schedule one or more PDSCHs 305 across the two subBWPs, schedule one or more PDSCHs 305 in a same subBWP (e.g., self-schedule data signals), or both.

In some implementations, the network entity may schedule the one or more PDSCHs 305 according to a scheduling delay. The scheduling delay may be indicated by a delay value (e.g., K0 or K2), which may indicate a quantity of slots 310, a time delay, or both between a scheduling DCI 315 and a corresponding PDSCH 305. Additionally, or alternatively, the scheduling delay may indicate that the PDSCH 305 may be scheduled in at least a next slot 310 after the scheduling DCI 315. That is, to schedule a PDSCH 305, the network entity may transmit a DCI 315 to schedule the PDSCH 305, where the DCI 315 may include a scheduling delay (e.g., K0) that corresponds to a time delay (e.g., in slots, symbols, mini-slots, among other examples) from reception of the DCI 315 to a start of the PDSCH 305 transmission.

In some examples, the network entity may schedule the PDSCHs 305 according to a minimum scheduling delay (e.g., K0>0) such that the PDSCH 305 is scheduled in a different slot 310 than the scheduling DCI 315 (e.g., avoiding same slot scheduling). For example, the network entity may indicate for the UE to switch from a subBWP 325 to a subBWP 330, and the network entity may correspondingly schedule a in either the subBWP 325 or the subBWP 330 according to a minimum scheduling delay via a DCI 315 transmitted according to the subBWP 330. The network entity may schedule the PDSCH 305 according to the minimum scheduling delay (e.g., K0>0) such that the one or more PDSCHs 305 is scheduled in a different slot than reception of the corresponding DCI 315. In such examples, the UE may adapt one or more operating parameters (e.g., adapt radio frequency parameters) associated with the subBWP 325 to receive the PDSCH 305 in the subBWP 330 that is different from the first subBWP, or the UE may remain operating according to the subBWP 330.

For example, the UE may operate according to the subBWP 325 (e.g., subBWP0, S0, or low power subBWP), and the network entity may output a scheduling DCI 315-a within a slot 310-b. The scheduling DCI 315-a may schedule a corresponding (e.g., subsequent) PDSCH 305-a and may include an indication of a scheduling delay K0>0 and an indication of a subBWP associated with the PDSCH 305-a. In such examples, the network entity may schedule the PDSCH 305-a via the scheduling DCI 315-a in a slot 310-c and according to a subBWP 330 (e.g., subBWP1, S1, or high-power subBWP). As such, the network entity may schedule the PDSCH 305-a as a cross-subBWP PDSCH 305 according to a minimum scheduling delay, and the UE may adapt one or more operating parameters to receive and decode the PDSCH 305-a during the slot 310-c (e.g., the UE may switch from the subBWP 325 to the subBWP 330 and receive the PDSCH 305-a). In another example, the UE may operate according to the subBWP 330 and may receive a scheduling DCI 315-b in a slot 310-e scheduling a PDSCH 305-b in a slot 310-f (e.g., a subsequent slot). Accordingly, the UE may switch from monitoring the subBWP 330 to monitoring the subBWP 325 and may receive the PDSCH 305-b.

Additionally, or alternatively, the network entity may schedule the one or more PDSCHs 305 within a same slot 310 as the scheduling DCI (e.g., same slot scheduling). The network entity may schedule the PDSCHs 305 within the same slot 310 as the DCI based on a capability of the UE (e.g., UE support for same slot scheduling). In such examples, the UE may utilize a relatively large set of frequency resources (e.g., wide bandwidth, or wide RF) for the PDSCH 305, for a corresponding physical uplink shared channel (PUSCH) communication, or both. The UE may utilize the large set of frequency resources based on receiving a narrow PDSCH (e.g., according to the subBWP 325), on receiving a wide PDSCH (e.g., according to the subBWP 330), or both.

In some implementations, the network entity may schedule (e.g., self-schedule) the one or more PDSCHs 305 within a same slot and according to a same subBWP as an associated scheduling DCI 315. For example, the UE operate according to the subBWP 325 and may receive a scheduling DCI 315-c within a slot 310-a scheduling a PDSCH 305-c within the same slot 310-a (e.g., according to a scheduling delay K0=0, or no scheduling delay). Accordingly, the UE may receive the PDSCH 305-c within the slot 310-a based on operating according to the subBWP 325 (e.g., without switching subBWPs). For another example, the UE operate according to the subBWP 330 and may receive a scheduling DCI 315-d within a slot 310-d scheduling a PDSCH 305-d within the same slot 310-d (e.g., according to a scheduling delay K0=0, or no scheduling delay). Accordingly, the UE may receive the PDSCH 305-d within the slot 310-d based on operating according to the subBWP 330 (e.g., without switching subBWPs).

Additionally, or alternatively, the network entity may schedule (e.g., self-schedule) the one or more PDSCHs 305 as cross-subBWP PDSCHs 305 within a same slot as an associated scheduling DCI 315 (e.g., same slot cross-subBWP scheduling). For example, the UE may operate according to the subBWP 330 within the slot 310-e. The UE may receive a scheduling DCI 315-e scheduling a PDSCH 305-e within the slot 310-e (e.g., within a same slot according to a scheduling delay K0=0, or no scheduling delay). Accordingly, the UE may switch from the subBWP 330 to the subBWP 325 and receive the PDSCH 305-e within the same slot 310-e. As such, the network entity may schedule the PDSCH 305-e as a cross-subBWP PDSCH 305 according to a same slot scheduling.

In some implementations, the UE may receive one or more control channel messages via a CORESET having a relatively greater quantity of time resources (e.g., a long CORESET, or a CORESET including at least three symbols). For example, the UE may monitor resources according to the subBWP 325 (e.g., the low power subBWP), and the UE may correspondingly monitor for the one or more control channel messages via a CORESET (e.g., a second CORESET) having a greater quantity (e.g., greater duration) than one or more CORESETs associated with the subBWP 330, or the like. For example, the UE may receive the scheduling DCI 315-a within the slot 310-b while monitoring the subBWP 325 according to a CORESET (e.g., a long CORESET) corresponding to a greater duration than a CORESET associated with reception of the scheduling DCI 315-d within the slot 310-d while monitoring the subBWP 330. In such examples, the CORESET (e.g., the long CORESET) may enable the UE to obtain the control channel message irrespective of an aggregation level associated with the subBWP 325 (e.g., to compensate for the higher aggregation levels).

Additionally, or alternatively, the UE may receive one or more control channel messages while monitoring according to the subBWP 325 via higher aggregation levels in accordance with monitoring multiple search space sets (SSSs). For example, the UE may utilize one or more CCEs as a union across the multiple SSSs. Each SSS of the multiple SSSs may be associated with a same CORESET or one or more different CORESETs.

In some implementations, the UE may utilize a relatively longer processing timeline to decode the control channel messages while monitoring according to the subBWP 330 (e.g., a relaxed timeline). For example, the UE may monitor resources according to the wide subBWP 330 and may receive a narrow control channel message (e.g., a control channel message having a narrow bandwidth compared to the bandwidth of the subBWP 330 such as a control channel message corresponding to the subBWP 325, among other examples). In such examples, the UE may utilize a processing timeline having a relatively greater duration than a processing timeline associated with a wide control channel message. Accordingly, the UE may decode the control channel message according to one or more timing parameters providing for the longer timeline. For example, a processing time parameter N1, a feedback time parameter K1 (e.g., indicating a time between control channel reception and feedback transmission), or both may correspond to relatively greater values to provide for the longer timeline (e.g., relaxation of N1 timeline, K1 timeline, or both).

For an illustrative example, the UE may receive the scheduling DCI 315-d while monitoring the subBWP 330 during the slot 310-d, and the scheduling DCI 315-d may be a narrow control message (e.g., a special format DCI, or the like). Accordingly, the UE may utilize a long processing timeline (e.g., corresponding to a relaxed N1 value, a relaxed K1 value, or both) to decode the scheduling DCI 315-d. For example, the UE may utilize a longer processing timeline to decode the scheduling DCI 315-d compared to a processing timeline utilized to decode the scheduling DCI 315-a received within the slot 310-b according to the subBWP 325.

FIG. 4 shows an example of a state diagram 400 that supports control channel monitoring in wireless communications systems in accordance with one or more aspects of the present disclosure. Aspects of the state diagram 400 may implement, or be implemented by, aspects of the wireless communications system 100, the wireless communications system 200, and the timing diagram 300, as described herein with reference to FIGS. 1 through 3. For example, the state diagram 400 may represent an operation of a network entity, a UE, or both, which may be examples of the network entity 105 and the UE 115, respectively.

In some implementations, the network entity may output, and the UE may receive, control signaling including an indication of one or more BWP configurations. For example, a BWP configuration may include one or more subBWP configurations, such as a subBWP0 (e.g., a low power subBWP, a narrow subBWP, subBWP 215, or the like), a subBWP1 (e.g., a high-power subBWP, a wide subBWP, subBWP 225, or the like), or both, which may be represented by a state 405 and a state 410, respectively. The state 405 and the state 410 may be associated with (e.g., include an indication of) a set of parameters corresponding to a respective subBWP, a rank, a scheduling delay, a minimum scheduling delay, a search space set group, or any combination thereof. For example, the state 405 may be associated with a subBWP0, a rank maxrank0, a scheduling delay K0, a minimum scheduling delay min0, a search space set group SSSG0, or any combination thereof corresponding to the subBWP0, and the state 410 may be associated with a subBWP1, a rank maxrank2, a scheduling delay K0, a minimum scheduling delay min1, a search space set group SSSG1, or any combination thereof corresponding to the subBWP1.

In some implementations, the UE may switch between the state 405 and the state 410 according to one or more triggers 415. For example, the UE may monitor resources according to the subBWP0 in accordance with the state 405, and the UE may receive, as a trigger 415-a, an indication (e.g., an indication 220) to switch to operating according to the state 410 (e.g., switch to the subBWP1). Accordingly, the UE may transition to the state 410 (e.g., switch to monitoring resources according to the subBWP1 in accordance with the trigger 415-a). Similarly, the UE may operate using the subBWP1, and the UE may receive, as a trigger 415-b, an indication (e.g., indication 220) for the UE to switch to operating according to the state 405 (e.g., switch to the subBWP0). Accordingly, the UE may transition to the state 405 (e.g., switch to monitoring resources according to the subBWP0).

In some implementations, the UE may transition from the subBWP0 (e.g., narrow subBWP) to the subBWP1 (e.g., wide subBWP) to monitor for one or more control channel receptions in response to the trigger 415-a. The transition to the wide subBWP for control channel monitoring may be temporary. In such examples, the UE may transition to the subBWP1 and perform one or more serving cell measurements (e.g., one or more signal power measurements, or the like). In such examples, the UE may remain operating according to the subBWP1 (e.g., the state 410) until the serving cell measurement satisfies a measurement threshold (e.g., temporary until the measurement threshold is satisfied). That is, in response to the serving cell measurements being satisfied (e.g., the trigger 415-b), the UE may transition to the state 405 and operate according to the subBWP0. In such examples, the network entity may output an indication of the measurement threshold, the measurement threshold may be preconfigured (e.g., an indication of the threshold measurement threshold may be stored at the UE), or both.

In some implementations, the UE may switch from monitoring the subBWP0 to monitoring the subBWP1 based on one or more events (e.g., triggers 415, such as satisfying). In some examples, based on a combination of a PDCCH CQI reported by the UE, a quantity of activated antennas for receiving the PDCCH, and a threshold (e.g., configured by the network), the UE may transition to monitor a PDCCH in the subBWP1 to support higher aggregation levels. For example, the UE may operate according to the subBWP0. Accordingly, based on the PDCCH CQI satisfying a first threshold, on a quantity of active antennas at the UE satisfying a second threshold, and/or based on a combination of the PDCCH CQI and the quantity of active antennas at the UE satisfying a third threshold, the UE may transition to operating according to the subBWP1 for reception of the PDCCH.

In some other examples, based on serving cell measurements RLM (e.g., measuring synchronization signal blocks (SSBs)) and a threshold (e.g., configured by the network on CQI), the UE may transition to monitor the PDCCH in the subBWP1 to support higher aggregation levels. For example, the UE may operate according to the subBWP0. Accordingly, based on the serving cell measurements satisfying a first threshold, the UE may transition to operating according to the subBWP1 for reception of the PDCCH.

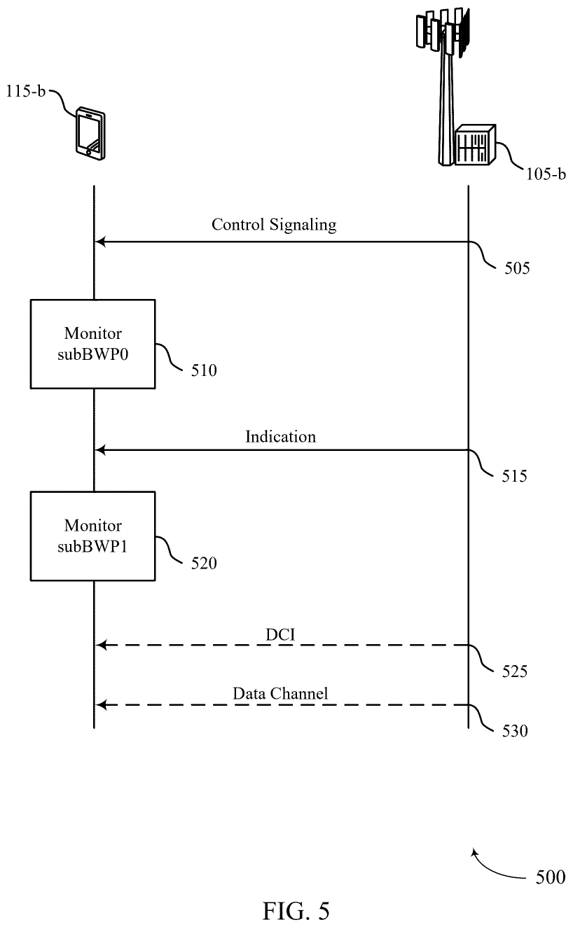

FIG. 5 shows an example of a process flow 500 that supports control channel monitoring in wireless communications systems in accordance with one or more aspects of the present disclosure. Aspects of the process flow 500 may implement or be implemented by aspects of the wireless communications system 100, the wireless communications system 200, or both. For example, the process flow 500 may include a network entity 105-b and a UE 115-b, which may be examples of the network entity 105 and the UE 115 respectively.

In the following description of the process flow 500, the operations between the network entity 105-b and the UE 115-b may be performed in different orders or at different times. Some operations may also be left out of the process flow 500, or other operations may be added. Although the network entity 105-b and the UE 115-b are shown performing the operations of the process flow 500, some aspects of some operations may also be performed by one or more other wireless devices.

At 505, the network entity 105-b may output, and the UE 115-b may receive, control signaling indicating a BWP configuration including a first subBWP (e.g., subBWP1, high-power subBWP, wide subBWP, or the like), a first subBWP (e.g., subBWP0, low power subBWP, narrow subBWP, or the like), or both. In some examples, the subBWP1 may include a greater quantity of frequency resources than the subBWP0 (e.g., the subBWP1 may have a greater bandwidth than the subBWP0). At 510, the UE 115-b may monitor resources for control channel communications (e.g., control channel receptions) in accordance with the subBWP0 based on receiving the control signaling of 505.

At 515, the network entity 105-b may output, and the UE 115-b may receive, an indication to switch to monitoring the subBWP1 (e.g., monitoring resources indicated by the subBWP1 configuration). The indication may be received independent of a current subBWP of the UE 115-b as further described herein with reference to FIG. 2, and the indication may indicate for the UE 115-b to switch from the subBWP0 to the subBWP1 for monitoring, to switch from the subBWP1 to the subBWP0 for monitoring, or both as further described herein with reference to FIG. 4. At 520, the UE 115-b may switch to monitoring the subBWP1 based on receiving the indication of 515. In some examples, the UE 115-b may switch to monitoring the subBWP1 based on one or more events as further described herein with reference to FIG. 4.

At 525, the network entity 105-b may output, and the UE 115-b may receive, a DCI based on monitoring the subBWP1. The DCI may schedule communications via a data channel (e.g., via a PDSCH, or the like). In some examples, the DCI may schedule communications via the data channel according to the subBWP0 (e.g., cross-subBWP scheduling) or the subBWP1 (e.g., self-scheduling), and the DCI may schedule communications via the data channel according to a scheduling delay as further described herein with reference to FIG. 3. For example, the DCI may schedule communications via the data channel within a same slot as the DCI (e.g., same slot scheduling) or within a subsequent slot according to the scheduling delay. In some examples, the communications may be associated with a minimum scheduling delay (e.g., K0<0), and/or same slot scheduling may be based on a capability of the UE 115-b.

At 530, the UE 115-b may receive the scheduled communications via the data channel. For example, the UE 115-b may receive the scheduled communications according to the subBWP0 or the subBWP1 in accordance with the DCI of 525, and the UE 115-b may receive the scheduled communication in a slot according to the DCI of 525.

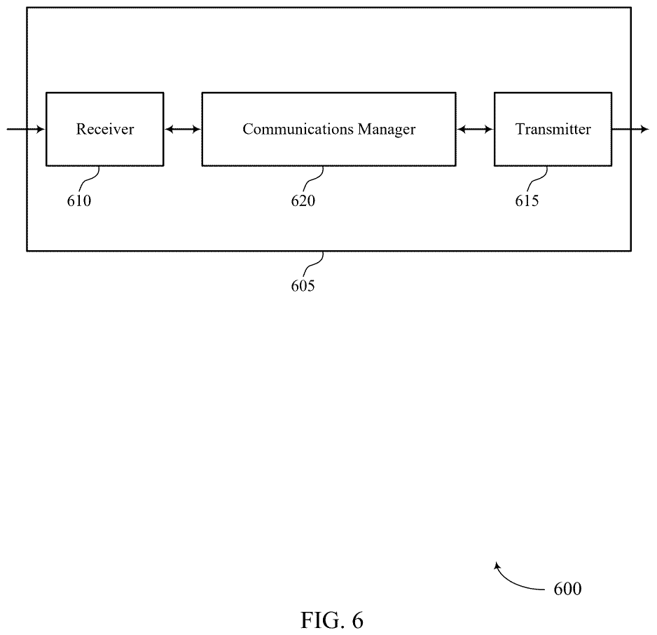

FIG. 6 shows a block diagram 600 of a device 605 that supports control channel monitoring in wireless communications systems in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to control channel monitoring in wireless communications systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to control channel monitoring in wireless communications systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of control channel monitoring in wireless communications systems as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling that indicates a first subBWP of a BWP and a second subBWP of the BWP, where a first set of frequency resources associated with the first subBWP is greater than a second set of frequency resources associated with the second subBWP. The communications manager 620 is capable of, configured to, or operable to support a means for receiving, via the second subBWP, an indication to monitor the first subBWP for reception of a control channel. The communications manager 620 is capable of, configured to, or operable to support a means for monitoring the first subBWP for the reception of the control channel in accordance with the indication.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources, among other benefits.

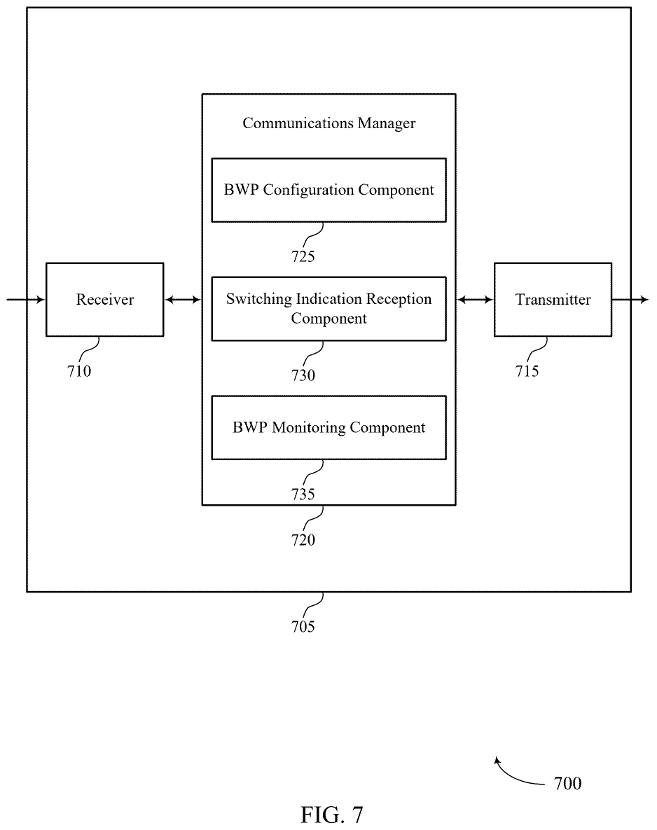

FIG. 7 shows a block diagram 700 of a device 705 that supports control channel monitoring in wireless communications systems in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to control channel monitoring in wireless communications systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to control channel monitoring in wireless communications systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of control channel monitoring in wireless communications systems as described herein. For example, the communications manager 720 may include a BWP configuration component 725, a switching indication reception component 730, a BWP monitoring component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The BWP configuration component 725 is capable of, configured to, or operable to support a means for receiving control signaling that indicates a first subBWP of a BWP and a second subBWP of the BWP, where a first set of frequency resources associated with the first subBWP is greater than a second set of frequency resources associated with the second subBWP. The switching indication reception component 730 is capable of, configured to, or operable to support a means for receiving, via the second subBWP, an indication to monitor the first subBWP for reception of a control channel. The BWP monitoring component 735 is capable of, configured to, or operable to support a means for monitoring the first subBWP for the reception of the control channel in accordance with the indication.

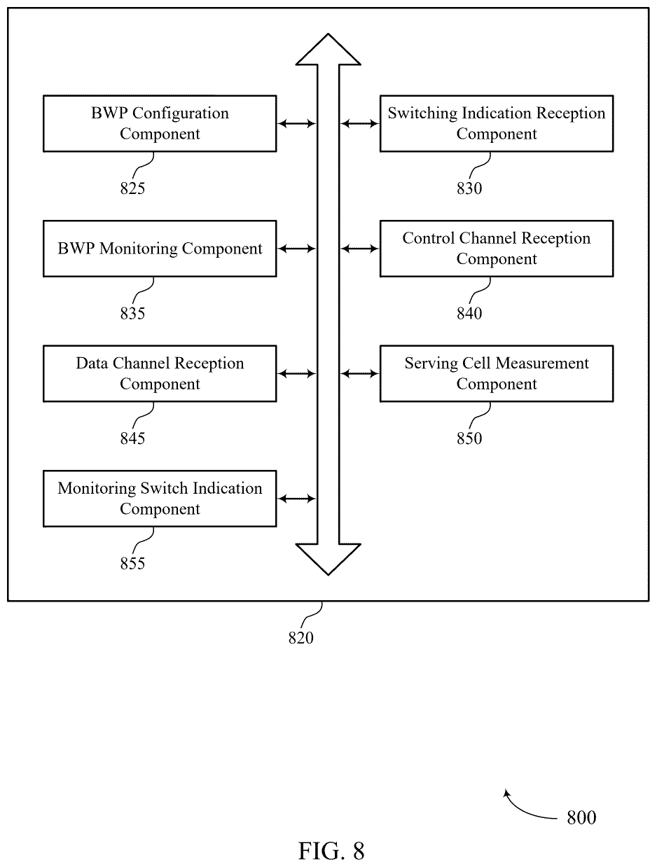

FIG. 8 shows a block diagram 800 of a communications manager 820 that supports control channel monitoring in wireless communications systems in accordance with one or more aspects of the present disclosure. The communications manager 820 may be an example of aspects of a communications manager 620, a communications manager 720, or both, as described herein. The communications manager 820, or various components thereof, may be an example of means for performing various aspects of control channel monitoring in wireless communications systems as described herein. For example, the communications manager 820 may include a BWP configuration component 825, a switching indication reception component 830, a BWP monitoring component 835, a control channel reception component 840, a data channel reception component 845, a serving cell measurement component 850, a monitoring switch indication component 855, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The BWP configuration component 825 is capable of, configured to, or operable to support a means for receiving control signaling that indicates a first subBWP of a BWP and a second subBWP of the BWP, where a first set of frequency resources associated with the first subBWP is greater than a second set of frequency resources associated with the second subBWP. The switching indication reception component 830 is capable of, configured to, or operable to support a means for receiving, via the second subBWP, an indication to monitor the first subBWP for reception of a control channel. The BWP monitoring component 835 is capable of, configured to, or operable to support a means for monitoring the first subBWP for the reception of the control channel in accordance with the indication.

In some examples, the control channel reception component 840 is capable of, configured to, or operable to support a means for receiving, in accordance with monitoring the first subBWP and via the control channel, DCI that schedules communication of a data channel via one of the first subBWP or the second subBWP. In some examples, the data channel reception component 845 is capable of, configured to, or operable to support a means for receiving the data channel via one of the first subBWP or the second subBWP in accordance with the DCI.

In some examples, the data channel reception component 845 is capable of, configured to, or operable to support a means for receiving, via the DCI, an indication of a time offset between reception of the DCI and reception of the data channel, where the time offset is greater than zero, and where the data channel is received in accordance with the time offset.

In some examples, the time offset indicates that reception of the data channel corresponds to a first slot that is subsequent to a second slot associated with reception of the DCI.

In some examples, the DCI is received in a first slot and schedules the communication of the data channel in the first slot. In some examples, the data channel is received via the first slot.

In some examples, the DCI schedules the data channel in the second subBWP, the UE decodes the data channel received via the second subBWP according to a first duration, and the UE communicates feedback associated with the data channel received via the second subBWP according to a second duration. In some examples, the DCI schedules the data channel in the first subBWP, the UE decodes the data channel received vis the first subBWP according to a third duration, and the UE communicates feedback associated with the data channel received via the first subBWP according to a fourth duration.

In some examples, the first duration is greater than the third duration and the second duration is greater than the fourth duration.

In some examples, the serving cell measurement component 850 is capable of, configured to, or operable to support a means for obtaining, while monitoring the first subBWP, one or more serving cell measurements. In some examples, the BWP monitoring component 835 is capable of, configured to, or operable to support a means for switching to monitor the second subBWP in accordance with the one or more serving cell measurements satisfying one or more thresholds.

In some examples, the switching indication reception component 830 is capable of, configured to, or operable to support a means for receiving, while monitoring the first subBWP, a second indication to monitor the second subBWP. In some examples, the BWP monitoring component 835 is capable of, configured to, or operable to support a means for monitoring the second subBWP in accordance with the indication.

In some examples, the BWP monitoring component 835 is capable of, configured to, or operable to support a means for monitoring the second subBWP for reception of a second control channel. In some examples, the BWP monitoring component 835 is capable of, configured to, or operable to support a means for switching from monitoring the second subBWP to monitoring the first subBWP in accordance with a combination of a CQI of the second control channel and a quantity of activated antennas at the UE for receiving the second control channel satisfying a threshold.

In some examples, the monitoring switch indication component 855 is capable of, configured to, or operable to support a means for transmitting an indication indicating that the UE is to monitor the first set of frequency resources in response to the switching.

In some examples, the BWP monitoring component 835 is capable of, configured to, or operable to support a means for monitoring the second subBWP for reception of a second control channel. In some examples, the BWP monitoring component 835 is capable of, configured to, or operable to support a means for switching from monitoring the second subBWP to monitoring the first subBWP in accordance with one or more SSB measurements satisfying a threshold.

In some examples, the BWP monitoring component 835 is capable of, configured to, or operable to support a means for monitoring a CORESET associated with the second subBWP for a second control channel, where the CORESET includes three or more symbols.

In some examples, the indication includes a DCI message associated with a first DCI format. In some examples, the first DCI format is associated with a first payload size that is smaller than a second payload size associated with a second DCI format that is utilized for scheduling one or more data channels. In some examples, the first DCI format is associated with a first CRC size that is smaller than a second CRC size associated with the second DCI format.

In some examples, the indication includes a single bit of a DMRS.

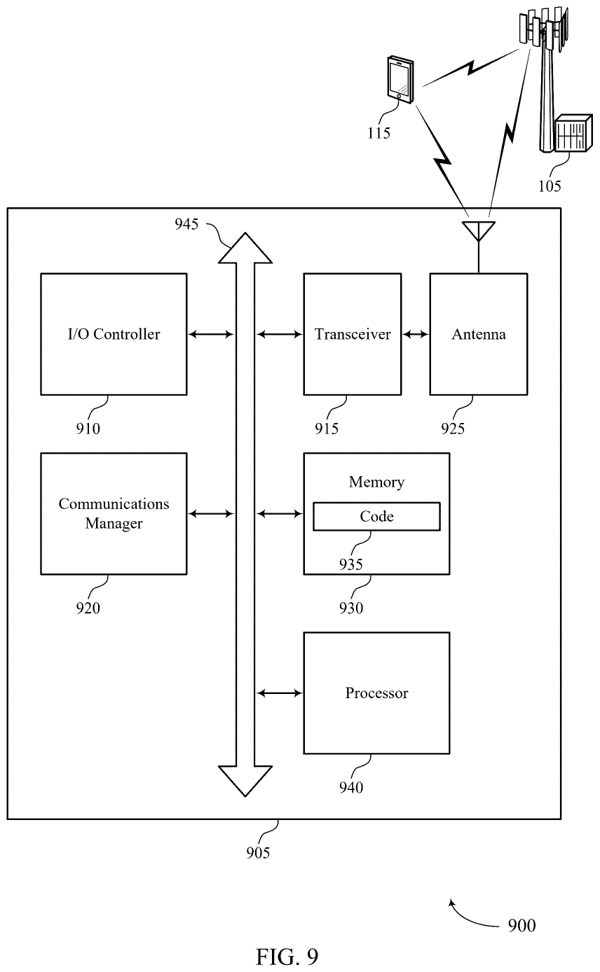

FIG. 9 shows a diagram of a system 900 including a device 905 that supports control channel monitoring in wireless communications systems in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting control channel monitoring in wireless communications systems). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling that indicates a first subBWP of a BWP and a second subBWP of the BWP, where a first set of frequency resources associated with the first subBWP is greater than a second set of frequency resources associated with the second subBWP. The communications manager 920 is capable of, configured to, or operable to support a means for receiving, via the second subBWP, an indication to monitor the first subBWP for reception of a control channel. The communications manager 920 is capable of, configured to, or operable to support a means for monitoring the first subBWP for the reception of the control channel in accordance with the indication.

By including or configuring the communications manager 920 in accordance with examples as described herein, the device 905 may support techniques for improved communication reliability, reduced latency, reduced power consumption, more efficient utilization of communication resources, and improved coordination between devices, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of control channel monitoring in wireless communications systems as described herein, or the at least one processor 940 and the at least one memory 930 may be otherwise configured to, individually or collectively, perform or support such operations.

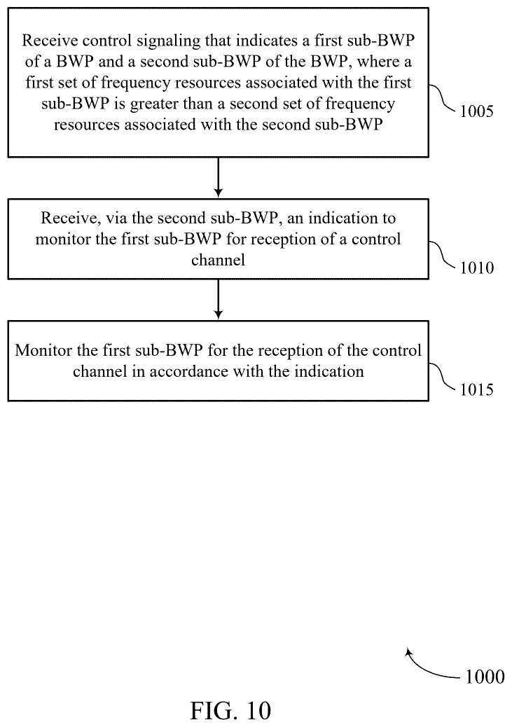

FIG. 10 shows a flowchart illustrating a method 1000 that supports control channel monitoring in wireless communications systems in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving control signaling that indicates a first subBWP of a BWP and a second subBWP of the BWP, where a first set of frequency resources associated with the first subBWP is greater than a second set of frequency resources associated with the second subBWP. The operations of 1005 may be performed in accordance with examples as disclosed herein. In some examples, aspects of the operations of 1005 may be performed by a BWP configuration component 825 as described with reference to FIG. 8.

At 1010, the method may include receiving, via the second subBWP, an indication to monitor the first subBWP for reception of a control channel. The operations of 1010 may be performed in accordance with examples as disclosed herein. In some examples, aspects of the operations of 1010 may be performed by a switching indication reception component 830 as described with reference to FIG. 8.

At 1015, the method may include monitoring the first subBWP for the reception of the control channel in accordance with the indication. The operations of 1015 may be performed in accordance with examples as disclosed herein. In some examples, aspects of the operations of 1015 may be performed by a BWP monitoring component 835 as described with reference to FIG. 8.

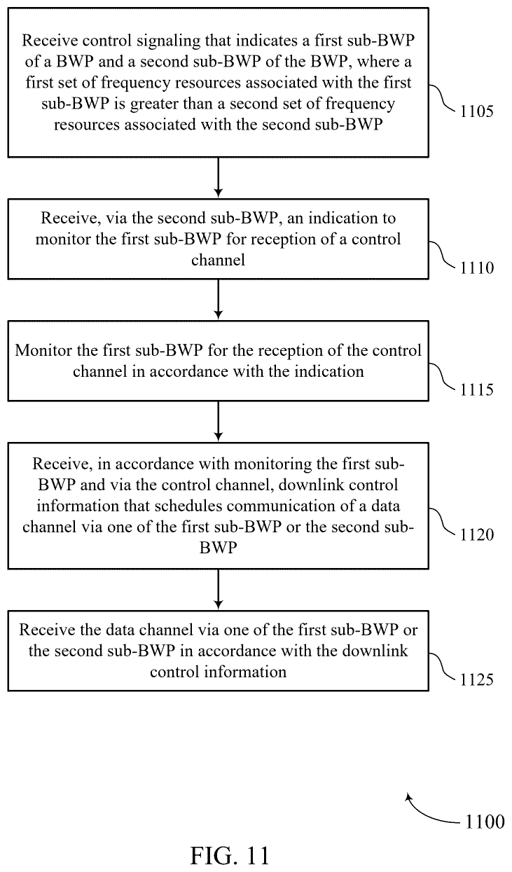

FIG. 11 shows a flowchart illustrating a method 1100 that supports control channel monitoring in wireless communications systems in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving control signaling that indicates a first subBWP of a BWP and a second subBWP of the BWP, where a first set of frequency resources associated with the first subBWP is greater than a second set of frequency resources associated with the second subBWP. The operations of 1105 may be performed in accordance with examples as disclosed herein. In some examples, aspects of the operations of 1105 may be performed by a BWP configuration component 825 as described with reference to FIG. 8.

At 1110, the method may include receiving, via the second subBWP, an indication to monitor the first subBWP for reception of a control channel. The operations of 1110 may be performed in accordance with examples as disclosed herein. In some examples, aspects of the operations of 1110 may be performed by a switching indication reception component 830 as described with reference to FIG. 8.

At 1115, the method may include monitoring the first subBWP for the reception of the control channel in accordance with the indication. The operations of 1115 may be performed in accordance with examples as disclosed herein. In some examples, aspects of the operations of 1115 may be performed by a BWP monitoring component 835 as described with reference to FIG. 8.

At 1120, the method may include receiving, in accordance with monitoring the first subBWP and via the control channel, DCI that schedules communication of a data channel via one of the first subBWP or the second subBWP. The operations of 1120 may be performed in accordance with examples as disclosed herein. In some examples, aspects of the operations of 1120 may be performed by a control channel reception component 840 as described with reference to FIG. 8.

At 1125, the method may include receiving the data channel via one of the first subBWP or the second subBWP in accordance with the DCI. The operations of 1125 may be performed in accordance with examples as disclosed herein. In some examples, aspects of the operations of 1125 may be performed by a data channel reception component 845 as described with reference to FIG. 8.

The following provides an overview of aspects of the present disclosure:

Aspect 1: A method for wireless communications at a UE, comprising: receiving control signaling that indicates a first subBWP of a BWP and a second subBWP of the BWP, wherein a first set of frequency resources associated with the first subBWP is greater than a second set of frequency resources associated with the second subBWP; receiving, via the second subBWP, an indication to monitor the first subBWP for reception of a control channel; and monitoring the first subBWP for the reception of the control channel in accordance with the indication.

Aspect 2: The method of aspect 1, further comprising: receiving, in accordance with monitoring the first subBWP and via the control channel, DCI that schedules communication of a data channel via one of the first subBWP or the second subBWP; and receiving the data channel via one of the first subBWP or the second subBWP in accordance with the DCI.

Aspect 3: The method of aspect 2, further comprising: receiving, via the DCI, an indication of a time offset between reception of the DCI and reception of the data channel, wherein the time offset is greater than zero, and wherein the data channel is received in accordance with the time offset.

Aspect 4: The method of aspect 3, wherein the time offset indicates that reception of the data channel corresponds to a first slot that is subsequent to a second slot associated with reception of the DCI.

Aspect 5: The method of any of aspects 2 through 3, wherein the DCI is received in a first slot and schedules the communication of the data channel in the first slot, the data channel is received via the first slot.

Aspect 6: The method of any of aspects 2 through 5, wherein the DCI schedules the data channel in the second subBWP, the UE decodes the data channel received via the second subBWP according to a first duration, and the UE communicates feedback associated with the data channel received via the second subBWP according to a second duration; or the DCI schedules the data channel in the first subBWP, the UE decodes the data channel received vis the first subBWP according to a third duration, and the UE communicates feedback associated with the data channel received via the first subBWP according to a fourth duration.

Aspect 7: The method of aspect 6, wherein the first duration is greater than the third duration and the second duration is greater than the fourth duration.

Aspect 8: The method of any of aspects 1 through 7, further comprising: obtaining, while monitoring the first subBWP, one or more serving cell measurements; and switching to monitor the second subBWP in accordance with the one or more serving cell measurements satisfying one or more thresholds.

Aspect 9: The method of any of aspects 1 through 7, further comprising: receiving, while monitoring the first subBWP, a second indication to monitor the second subBWP; and monitoring the second subBWP in accordance with the indication.

Aspect 10: The method of any of aspects 1 through 9, further comprising: monitoring the second subBWP for reception of a second control channel; and switching from monitoring the second subBWP to monitoring the first subBWP in accordance with a combination of a CQI of the second control channel and a quantity of activated antennas at the UE for receiving the second control channel satisfying a threshold.

Aspect 11: The method of aspect 10, further comprising: transmitting an indication indicating that the UE is to monitor the first set of frequency resources in response to the switching.

Aspect 12: The method of any of aspects 1 through 11, further comprising: monitoring the second subBWP for reception of a second control channel; and switching from monitoring the second subBWP to monitoring the first subBWP in accordance with one or more SSB measurements satisfying a threshold.

Aspect 13: The method of any of aspects 1 through 12, further comprising: monitoring a CORESET associated with the second subBWP for a second control channel, wherein the CORESET comprises three or more symbols.

Aspect 14: The method of any of aspects 1 through 7, wherein the indication comprises a DCI message associated with a first DCI format, the first DCI format is associated with a first payload size that is smaller than a second payload size associated with a second DCI format that is utilized for scheduling one or more data channels, and the first DCI format is associated with a first cyclic redundancy check size that is smaller than a second cyclic redundancy check size associated with the second DCI format.

Aspect 15: The method of any of aspects 1 through 7, wherein the indication comprises a single bit of a DMRS.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a first sub-bandwidth part of a bandwidth part and a second sub-bandwidth part of the bandwidth part, wherein a first set of frequency resources associated with the first sub-bandwidth part is greater than a second set of frequency resources associated with the second sub-bandwidth part;
receive, via the second sub-bandwidth part, an indication to monitor the first sub-bandwidth part for reception of a control channel; and
monitor the first sub-bandwidth part for the reception of the control channel in accordance with the indication.

2. The UE of claim 1, wherein the one or more processors are individually or collectively further operable to execute the code to cause the UE to:
receive, in accordance with monitoring the first sub-bandwidth part and via the control channel, downlink control information that schedules communication of a data channel via one of the first sub-bandwidth part or the second sub-bandwidth part; and
receive the data channel via one of the first sub-bandwidth part or the second sub-bandwidth part in accordance with the downlink control information.

3. The UE of claim 2, wherein the one or more processors are individually or collectively further operable to execute the code to cause the UE to:
receive, via the downlink control information, an indication of a time offset between reception of the downlink control information and reception of the data channel, wherein the time offset is greater than zero, and wherein the data channel is received in accordance with the time offset.

4. The UE of claim 3, wherein the time offset indicates that reception of the data channel corresponds to a first slot that is subsequent to a second slot associated with reception of the downlink control information.

5. The UE of claim 2, wherein the downlink control information is received in a first slot and schedules the communication of the data channel in the first slot, and wherein the data channel is received via the first slot.

6. The UE of claim 2, wherein:
the downlink control information schedules the data channel in the second sub-bandwidth part, the UE decodes the data channel received via the second sub-bandwidth part according to a first duration, and the UE communicates feedback associated with the data channel received via the second sub-bandwidth part according to a second duration; or
the downlink control information schedules the data channel in the first sub-bandwidth part, the UE decodes the data channel received vis the first sub-bandwidth part according to a third duration, and the UE communicates feedback associated with the data channel received via the first sub-bandwidth part according to a fourth duration.

7. The UE of claim 6, wherein the first duration is greater than the third duration and the second duration is greater than the fourth duration.

8. The UE of claim 1, wherein the one or more processors are individually or collectively further operable to execute the code to cause the UE to:
obtain, while monitoring the first sub-bandwidth part, one or more serving cell measurements; and
switch to monitor the second sub-bandwidth part in accordance with the one or more serving cell measurements satisfying one or more thresholds.

9. The UE of claim 1, wherein the one or more processors are individually or collectively further operable to execute the code to cause the UE to:
receive, while monitoring the first sub-bandwidth part, a second indication to monitor the second sub-bandwidth part; and
monitor the second sub-bandwidth part in accordance with the indication.

10. The UE of claim 1, wherein the one or more processors are individually or collectively further operable to execute the code to cause the UE to:
monitor the second sub-bandwidth part for reception of a second control channel; and
switch from monitoring the second sub-bandwidth part to monitoring the first sub-bandwidth part in accordance with a combination of a channel quality indicator of the second control channel and a quantity of activated antennas at the UE for receiving the second control channel satisfying a threshold.

11. The UE of claim 10, wherein the one or more processors are individually or collectively further operable to execute the code to cause the UE to:
transmit an indication indicating that the UE is to monitor the first set of frequency resources in response to the switching.

12. The UE of claim 1, wherein the one or more processors are individually or collectively further operable to execute the code to cause the UE to:
monitor the second sub-bandwidth part for reception of a second control channel; and
switch from monitoring the second sub-bandwidth part to monitoring the first sub-bandwidth part in accordance with one or more synchronization signal block measurements satisfying a threshold.

13. The UE of claim 1, wherein the one or more processors are individually or collectively further operable to execute the code to cause the UE to:
monitor a control resource set associated with the second sub-bandwidth part for a second control channel, wherein the control resource set comprises three or more symbols.

14. The UE of claim 1, wherein:
the indication comprises a downlink control information message associated with a first downlink control information format,
the first downlink control information format is associated with a first payload size that is smaller than a second payload size associated with a second downlink control information format that is utilized for scheduling one or more data channels, and
the first downlink control information format is associated with a first cyclic redundancy check size that is smaller than a second cyclic redundancy check size associated with the second downlink control information format.

15. The UE of claim 1, wherein the indication comprises a single bit of a demodulation reference signal.

16. A method for wireless communications at a user equipment (UE), comprising:
receiving control signaling that indicates a first sub-bandwidth part of a bandwidth part and a second sub-bandwidth part of the bandwidth part, wherein a first set of frequency resources associated with the first sub-bandwidth part is greater than a second set of frequency resources associated with the second sub-bandwidth part;
receiving, via the second sub-bandwidth part, an indication to monitor the first sub-bandwidth part for reception of a control channel; and
monitoring the first sub-bandwidth part for the reception of the control channel in accordance with the indication.

17. The method of claim 16, further comprising:
receiving, in accordance with monitoring the first sub-bandwidth part and via the control channel, downlink control information that schedules communication of a data channel via one of the first sub-bandwidth part or the second sub-bandwidth part; and
receiving the data channel via one of the first sub-bandwidth part or the second sub-bandwidth part in accordance with the downlink control information.

18. The method of claim 17, further comprising:
receiving, via the downlink control information, an indication of a time offset between reception of the downlink control information and reception of the data channel, wherein the time offset is greater than zero, and wherein the data channel is received in accordance with the time offset.

19. The method of claim 18, wherein the time offset indicates that reception of the data channel corresponds to a first slot that is subsequent to a second slot associated with reception of the downlink control information.

20. A non-transitory computer-readable medium storing code for wireless communications, the code comprising instructions executable by one or more processors to:
receive control signaling that indicates a first sub-bandwidth part of a bandwidth part and a second sub-bandwidth part of the bandwidth part, wherein a first set of frequency resources associated with the first sub-bandwidth part is greater than a second set of frequency resources associated with the second sub-bandwidth part;
receive, via the second sub-bandwidth part, an indication to monitor the first sub-bandwidth part for reception of a control channel; and
monitor the first sub-bandwidth part for the reception of the control channel in accordance with the indication.
